(19) United States
(12) Patent Application Publication
(10) Pub. No.: US 2012/0151137 A1
(43) Pub. Date: Jun. 14, 2012

(54) MULTIMEDIA DEVICE WITH DATA RECOVERY FUNCTION

(75) Inventor: CHIN-JUI HSU, Tu-Cheng (TW)

(73) Assignee: HON HAI PRECISION INDUSTRY CO., LTD., Tu-Cheng (TW)

(21) Appl. No.: 13/089,226

(22) Filed: Apr. 18, 2011

(30) Foreign Application Priority Data
Dec. 10, 2010 (TW) 99143159

(51) Int. Cl. G06F 12/00

(52) U.S. Cl. 711/114; 711/E12.001

(57) ABSTRACT

A multimedia device includes a display, a multimedia processing unit, and a storage unit. The storage unit is connected to the display and multimedia processing unit. The multimedia processing unit includes a redundant array of independent disk (RAID) module. The storage unit includes a plurality of HDDs. If data stored in any of the HDD(s) is damaged, and the RAID module recovers the damaged data according to other HDD(s).

### BACKGROUND

1. Technical Field

The disclosure generally relates to multimedia devices, and particularly to a multimedia device with a data recovery function.

2. Description of Related Art

Multimedia devices, such as game consoles and digital photo frames, are widely used in every day life. Users can play games or listen to music with a multimedia device not merely watch videos or view photos. However, glitches do occur and data may be lost or damaged. Therefore, a data recovery function needs to be implemented in the multimedia devices.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 shows a multimedia device which includes a display, a multimedia processing unit, and a storage unit, according to an exemplary embodiment.

FIG. 2 is a block diagram of one embodiment of the multimedia device of FIG. 1.

### DETAILED DESCRIPTION

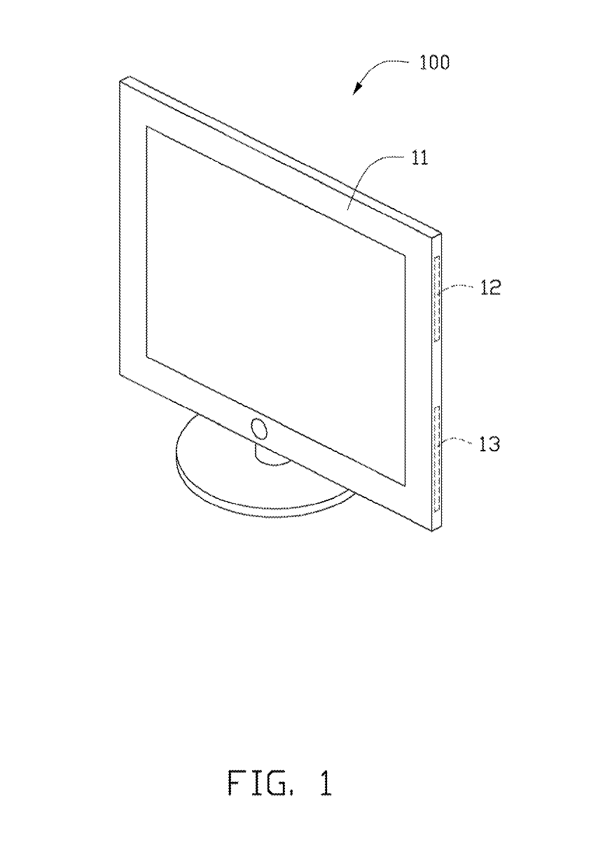

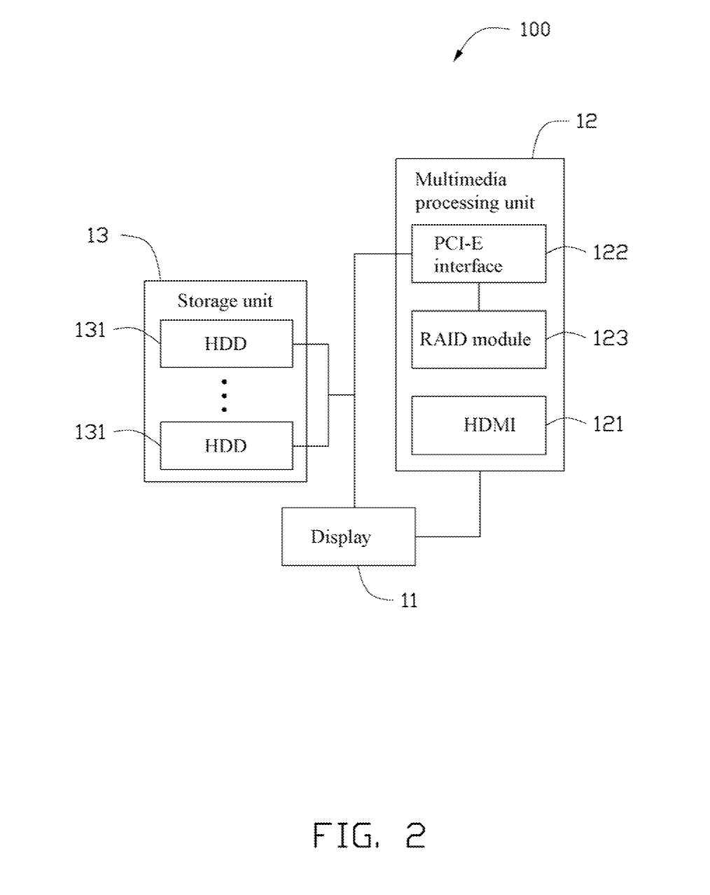

FIG. 1 shows a multimedia device 100 which includes a display 11, a multimedia processing unit 12, and a storage unit 13, according to an exemplary embodiment. Also referring to FIG. 2, the multimedia processing unit 12 and the storage unit 13 are connected to the display unit 11.

The display 11 may be a liquid crystal display (LCD) display. The multimedia processing unit 12 and the storage unit 13 are included inside the display 11. The multimedia processing unit 12 includes multiple application programs, such as browsing programs, display programs, document management programs and simulation programs. The browsing programs support users to search, browse or download multimedia files from the internet by the display 11. The multimedia files may be pictures, videos or games. The display programs are used to support a player such as a Blu-ray DVD to execute the multimedia files. The document management programs support users to mange (i.e., copy, delete, or move) the multimedia files. The simulation programs are used to execute games and simulate game environments for the users.

The multimedia processing unit 12 further includes a high definition multimedia interface (HDMI) 121, a peripheral component interconnect express (PCI-E) interface 122, and a redundant array of independent disks (RAID) module 123. The HDMI 121 is connected to the display 11, and is used for transmitting uncompressed data. The RAID module 123 is connected to the storage unit 13 by the PCI-E interface 122. The RAID module 123 can be any of multiple standard RAID levels. In this embodiment, the RAID module 123 is a RAID 5 array.

The storage unit 13 includes a plurality of hard disk drives (HDDs) 131. The HDDs 131 store data for the multimedia devices 100. Each HDD 131 may include a corresponding verifying code. If data in any of the HDD(s) 131 is damaged, the RAID module 123 recovers the damaged data according to the verifying codes of other HDDs 131. Therefore, the damaged data is recovered without negative impact on the users. The multimedia device 100 integrated with a RAID module 123 can recover the damaged data in the storage unit 13 and has reliable performances.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A multimedia device comprising:
a display;
a multimedia processing unit connected to the display, the multimedia processing unit including a redundant array of independent disk (RAID) module; and
a storage unit connected to the display and the multimedia processing unit, the storage unit including a plurality of HDDs; wherein if data stored in any of the HDD(s) is damaged, and the RAID module recovers the damaged data according to other HDD(s).

2. The multimedia device as claimed in claim 1, wherein multimedia processing unit further includes a peripheral component interconnect express (PCI-E) interface, the RAID module is connected to the storage unit by the PCI-E interface.

3. The multimedia device as claimed in claim 2, wherein the multimedia processing unit includes a high definition multimedia interface (HDMI) connected to the display.

4. The multimedia device as claimed in claim 1, wherein each HDD includes a corresponding verifying code.

5. The multimedia device as claimed in claim 4, wherein the RAID module recovers the damaged data according to the corresponding verifying codes of other HDDs.

6. The multimedia device as claimed in claim 1, wherein the multimedia processing unit includes browsing programs, display programs, document management programs and simulation programs.

7. The multimedia device as claimed in claim 1, wherein the RAID module is a RAID 5 array.
